(19) United States
(12) Patent Application Publication
(10) Pub. No.: US 2007/0198155 A1
(43) Pub. Date: Aug. 23, 2007

(54) METHOD AND APPARATUS FOR SENSING IMPACT BETWEEN A VEHICLE AND AN OBJECT

(75) Inventor: Lee A. Danisch, Fredericton, New Brunswick (CA)

Correspondence Address: CARTER, DELUCA, FARRELL & SCHMIDT, LLP, 445 BROAD HOLLOW ROAD, SUITE 225, MELVILLE, NY, 11747, US

(73) Assignee: 059312 N.B. INC., Fredericton, New Brunswick (CA)

(21) Appl. No.: 11/691,058

(22) Filed: May 11, 2007

Related U.S. Application Data
(63) Continuation-in-part of application No. 11/228,304, filed on Sep. 19, 2005.

(30) Foreign Application Priority Data
Apr. 6, 2004 (CA) PCT/CA04/00518
Aug. 4, 2003 (CA) 2424708

(51) Int. Cl. E05F 15/00; B60K 28/10; G01J 1/04

(52) U.S. Cl. 701/45; 180/274; 250/227.15

(57) ABSTRACT

The invention relates to the apparatus for and a method of sensing impact between a vehicle and an object and particularly between a pedestrian and the front bumper (12) of a vehicle. An optical fiber array (14) extends along the bumper (12) and the array (14) has sensors spaced along the bumper (12). A sensor comprises light loss areas spaced peripherally and axially on a fiber. An impact distorts the sensors, modulating light transmitted along the fiber or fibers. A signal is produced which is processed by a signal processor and an output signal generated. The output signal is used to actuate a safety device, such as elevating the vehicle hood to increase clearance between hood and engine, to reduce the severity of any injuries.

### FIELD OF THE INVENTION

This application is a continuation-in-part of U.S. patent application Ser. No. 11/228,304, filed on Sep. 19, 2005, which is a continuation of International Application No. PCT/CA04/00158, filed on Apr. 6, 2004.

This invention relates to the sensing of impact between objects and a vehicle, and in particular to classification of the impacts to discern whether a pedestrian has impacted the front bumper of a vehicle. The invention also relates to the use of such sensing to actuate a safety device for the reduction of the severity of injury which may occur due to such impacts.

### BACKGROUND OF THE INVENTION

It is an urgent requirement that the severity of injury to a pedestrian resulting from impact with a vehicle be reduced. A particular event such as a pedestrian being in impact with the bumper of a vehicle can result in serious head injuries by the head striking the hood. Although some deformation of the hood can occur, the degree of deformation is restricted by the solid metal of the engine beneath. One possibility that has been proposed is for the hood to be “popped” open to provide some increase in the clearance between hood and engine, allowing increased deformation of the hood. In the case of sensing pedestrian impact, it is also desirable to distinguish whether the impact is due to contact with a pedestrian or something other than a pedestrian, e.g. a pole. Distinguishing between the two is desired in order to deploy the appropriate safety system. In the case of pedestrian impact, in addition or in place of the use of an automobile hood, other safety devices can also be actuated, such as air bags.

### DISCUSSION OF THE PRIOR ART

It has been proposed to position impact sensing devices on a front bumper, to actuate some form of safety device on the occurrence of an impact. However there is a problem in obtaining clear satisfactory indication of an impact. One such proposal is described in U.S. Pat. No. 6,329,910, in which an elongate metal bar is positioned in the lower air dam area of a bumper, the bar comprising a magnetosensitive sensor and a stress-conducting member. Drawbacks to this method include limited flexibility of the components, unlikely return to a working condition after an impact, and interference from electrical fields and impulses. Prior art also includes piezoelectric films such as polyvinylidenedifluoride (PVDF) which produce an electrical current when bent. PVDF sensors suffer from variability of response, poor integrity of electrical connections when bent, and the requirement for high impedance circuitry with consequent reliability problems in wet environments. It is also possible to sense impacts with conductive rubber sensors, which change impedance when stressed or bent. Drawbacks include poor flexibility at low temperatures, material properties which must be tailored for both mechanical flexibility and electrical conduction, and changes in sensitivity to bending at different temperatures.

It has also been proposed to attach sensors to various members of a vehicle body, to detect and, in some cases, classify impacts between the vehicle and other vehicles or stationary objects. In such systems, one of the important features is to provide safety for the occupants of the vehicle. Classification of impacts enables a decision to be made as to whether a safety device such as an airbag should be deployed.

### SUMMARY OF THE INVENTION

The present invention is concerned with detecting and classifying impacts which are likely to be less strong and, frequently, may not result in any great danger to the occupants. An object of the present invention is to detect an impact between a pedestrian and a vehicle and actuate a safety device which will reduce possible injury to the pedestrian, while preventing actuation when impacts with other objects such as poles, barriers, and walls are detected.

Thus according to the present invention, apparatus for sensing impacts between a vehicle and an object, comprises an optical fiber sensor for positioning on the vehicle, the sensor including at least one optical fiber having a light source at one end and a light detector at the other end. The fiber has at least one sensing zone having a light-loss area located on the fiber periphery on a side of the fiber facing toward the direction of an expected impact and another light-loss area facing away from the direction of expected impact.

In one aspect of the present invention, an optical fiber array extends across and is attached to a bumper of a vehicle. The array can comprise at least one fiber. One or more sensor zones are provided on each fiber of the array, so that location as well as type of impact may be sensed because the locations of the zones will be known, and zones will be designed to sense a wide range of impact shapes and types, without missing important characteristics used in classification.

The form and arrangement of the sensor or sensors can vary considerably. Sensor zones may be formed according to prior art described in Danisch, L. A., Fiber optic bending and position sensor including a light emission surface formed on a portion of a light guide, U.S. Pat. No. 5,321,257, Jun. 14, 1994; Danisch, L. A., Fiber optic bending and position sensor with selected curved light emission surfaces, U.S. Pat. No. 5,633,494, May 27, 1997, Danisch, L. A., Fiber optic bending and position sensor, European Patent No. EP 0 702 780, Oct. 22, 1997, Danisch, L. A., Topological and motion measuring tool, U.S. Pat. No. 6,127,672, Oct. 3, 2000, Danisch, L. A., Danisch, J. F., and Lutes, J. P., Topological and motion measuring tool (II), U.S. Pat. No. 6,563,107, and Danisch, L. A., Transversely coupled fiber optic sensor for measuring and classifying contact and shape, Canadian Patent Application filed May 11, 1999.

In the above prior art, the sensors are designed with loss on one side, providing an asymmetrical loss and bipolar response, so that a sensor zone will respond with an increase in light throughput to a given polarity of bend, and have a decreased throughput for the opposite polarity of bend. The sensor zone on the fiber has a bipolar response, and each portion within the zone also has the bipolar response. Consequently, the overall response of the zone is the integral of curvature over the zone length, which amounts to the net angle from beginning to end of the zone. This is useful in maintaining angular accuracy for sensors that have curvature detail within a zone, but has the unfortunate consequence that inflected bends (bends containing positive and negative components) within the zone may sum to zero.

Impacts with vehicle fronts or sides usually result in ‘intrusions’ rather than simple bends. The distinction is that intrusions generally include positive and negative bends, so they can be called ‘inflected’. The intrusions from small objects like a pole or leg are often small in extent (1-6 cm) compared to the length of a bumper (1-2 meters).

Thus it is desirable to include sensor zones within an array that have a robust response to inflected bends (non-bipolar response) within individual sensing zones, yet maintain a significant light throughput when not impacted. Danisch '257 and '494 include descriptions of a fiber that loses light throughout its circumference and has such a non-bipolar response. However, the circumferential treatment does not meet the requirement for bumper sensing that the throughput be maintained over long sensor lengths or many short consecutive sensor lengths on the same fiber. It is thus a further object of this invention to provide a sensor that has non-bipolar response with high modulation from bending, and also has maximum throughput.

U.S. Pat. No. '494 describes sensors with loss surfaces that are arranged peripherally or axially. Because the impacted shape of a bumper is mainly within the horizontal plane, it is desirable to produce maximum modulation for impacts by providing light-loss surfaces within that plane, and to minimize light-loss within other planes intersecting the axis of the fiber. By making the light-loss surfaces symmetrical (i.e. one faces the impact, the other faces away), a completely non-bipolar response is obtained for impacts. If the surfaces have minimal peripheral extent, then light throughput is maintained.

In applications requiring response to more than one plane intersecting the axis of the fiber, more thin light-loss strips may be added around the circumference of the fiber. Alternatively, a light-loss strip may wind around the fiber in a helical shape. Impacted shapes also typically involve impacted pressure fields that occur at similar locations to the impact bends. It is possible to either ignore the pressure by designing the attachment of the sensors to exclude pressure effects but respond only to shape (such as by mounting the sensor in a slot within the bumper with free air on one side of the sensor), or to use pressure as the means of classifying shapes and measuring the time progression and mass of intrusion, with or without the combined measurement of bending. In this case the light-loss areas may be created by using the pressure of an impact to press a film with varying surface profile into the fiber at a known location at the time of Impact Suitable films include woven screens, sandpaper, and sinuated or waffle-patterned plastic. The impression film will create microbends in the fiber, which will result in light being lost from the core into the cladding or out of the cladding. Microbends are any series of small bends or sinuations along the length of an intended sensor location. The impression film may be located on the sides of the fiber facing away from and toward the impact, or on one side only. If located on both sides, the effects of light-loss due to pressure and of bending while losing light will be synergistic, and symmetrical to both directions of curvature, so it is preferable to have the impression film on both sides. If the impression film is located on one side only, the effects are synergistic for pressure and bend but will be less symmetrical for both directions of bend. Creation of loss surfaces by this method has the advantage that when the sensor is not being impacted, there is very little light-loss, so that the change upon impact is very large.

Whether the microbends are applied from both sides or one side of the fiber, the method differs from classical microbend sensing, wherein a fiber is compressed between two flat but waffled platens. In the method of this patent, the platens are flexible so that the fiber receives pressure and microbends, but is free also to flex, so that flexure produces additional light-loss due to increased interaction of light with the microbend-induced loss surfaces. A typical configuration for such a sensor is sandwiched between two layers of flexible foam or gel, which will transmit pressure fields but allow flexure. For this reason, included are microbend-inducing patterned films as a means of producing light-loss surfaces throughout this patent filing. In the case of arrays of sensors, the impression film may comprise a single film covering the entire array, with patterned areas on the film being placed at desired sensor locations (see FIG. 30).

A sensor meeting the objectives can comprise a single fiber having two loss surfaces in opposition extending along the length of the fiber, with a light source connected to one end and a light detector connected to the other end. While effective in indicating an impact, such a sensor cannot give any data as to the position of the impact along the bumper. Another similar arrangement is a single fiber extending in a loop for positioning of light source and light detector at the same end. Both legs of the loop can have a sensor or sensors, or only one length.

For more detailed information concerning the impact, a plurality of sensors can be positioned along a fiber. Alternatively a plurality of fibers can be provided, side-by-side, each fiber having a sensor, the sensors spaced along the bumper. A further alternative is a plurality of fibers extending side-by-side, with a plurality of sensors spaced along each fiber. In yet a further arrangement, a sensor can comprise a plurality of light-loss surfaces with varying pattern arrangements. Typical arrangements are surfaces spaced axially relative to each other, or spaced peripherally, or a combination of both. The surfaces can extend axially, peripherally or a combination, such as in a helix.

By suitably arranging the sensors across a bumper, it is possible to identify the position of the impact. The sizes and arrangement of light-loss surfaces can provide data concerning the impact.

The array of fibers may include bipolar and non-bipolar sensors, so that inflected shapes (e.g. dents) and non-inflected shapes (e.g. shallow curves of one polarity) may be differentiated.

The array of fibers may also include bipolar and non-bipolar sensors which have varying amounts of light-loss on one or both sides when straight, thereby imparting a region of operation over which the sensors have a given change in output per bend (slope), and regions over which the sensors have a different slope. The change in slope for a given sensor may occur at different absolute values of bend for positive and negative bend. Thus, these sensors have a region of absolute values of bend over which their response is linear, and two other ranges over which their responses are nonlinear.

The sensor or sensor system of the present invention will normally be utilized with an electronic control system; such control systems are well known in the art for use for various purposes (e.g. seatbelts, air bags, alarms, engine control, etc.). Generally speaking, such an electronic control system will employ an algorithm which will choose which sensor or sensors are most affected by an impact; the control system will also generally store a defined number (e.g. a few hundred) samples of the signal from the most affected sensor(s) in order to process the data obtained over a defined time period, and obtain a “calculation window”. The latter time period is relatively short compared to the time necessary to make a deployment decision.

Further, the algorithm may typically average several samples of early data and several samples of later data (avg 1, avg 2) and provide a calculation of the slope of avg 2 versus avg 1 (avg 2−avg 1 divided by time between them) which will yield a “rate” calculated for two groups of data separated by a gap. The electronic control system through the algorithm can also compute slopes for all groups of avg 1 and avg 2 samples of earliest data and samples of later data within a calculation window-in such an arrangement, avg1 and avg2 are separated by an equivalent amount of time (thus providing a “moving gap rate”). The slopes will be normalized according to measured speed of a vehicle as determined from other sensors (e.g. an ABS system). The information provided from such a system will generate a magnitude of slope which will indicate whether a pedestrian impact or some other type of impact (such as a pole) has occurred. The time when the slope begins to decrease markedly will indicate the peak time of an impact signal, which would form a classification index. Thus, the magnitude of the slope once the type of object is determined, together with speed information from e.g. the ABS system, will be used to determine a mass of the object and rate of intrusion into the bumper. This may be achieved by utilizing stored information which characterizes the system with test objects of known masses and various impact velocities which will determine calibration factors.

It is possible for algorithms such as the above to classify impacts measured by bipolar sensors or non-bipolar sensors. For instance, the bipolar sensors may be sufficiently numerous to resolve in part the shape of inflected curves. Or, bipolar or non-bipolar sensors may be used on the basis of locational information only being obtained from the array of sensors, while classification is achieved by calibrating the signal progression through time against the type of impact (e.g. type of object, mass, and rate of intrusion). It can be helpful in developing a classification algorithm to use mechanical, optical, and electronic models of the front end of the car, the bumper, the optical array on a substrate in the bumper, the optical fibers, the adhesive systems, and the signal processing, combined with extensive characterization by crash testing to validate the models, in order to get the most information and best classification from any given type of sensor.

Further, the front end construction may be changed to diminish bends of multiple polarities within a sensing zone. For instance, stiffness may be increased to prevent inflected bends from occurring on a scale where a single sensor would be subjected to both positive and negative bends. Or, a layer of resilient material like foam may be placed between a stiff front bumper and the sensory fibers. This will have the effect of absorbing inflected bends from the earliest portion of the impact when the contact area between an object and the bumper is small compared to a sensor length, and thereafter (after a short delay) transmitting all of the non-inflected bend.

For any type or configuration of sensor and front end construction, the classification accuracy may be optimized by using combinations of algorithms, testing, and modelling approaches. This invention is aimed at optimizing the locational and time-progression aspects of the signal contents, and minimizing the number of sensors required to make a classification.

The invention is concerned with the method of detecting, and where required, classifying impacts with a vehicle, and also an apparatus for such detection, and classification. Apparatus, in accordance with the invention, can comprise an optical fiber array, comprising one or more fibers, with one or more sensors, as an entity for attachment to a bumper. Light sources and detectors can be previously attached for the apparatus to be ready for applying and connection to the control unit-usually positioned within the vehicle. Alternatively, the light sources and detectors can be connected to the fiber array after the fiber array has been applied to the bumper.

A method, in accordance with the invention, comprises applying an optical fiber array to a bumper of a vehicle, the optical fiber array having one or more sensors extending along the array, each sensor having light-loss surfaces in opposition, detecting a variation in a light signal in the fiber array indication of an impact with and deformation of the bumper, producing an output signal related to the variation in light signal, and using the output to control actuation of a safety device.

In other cases also in accord with the invention, the light-loss surface within a sensor length is arranged to symmetrically include each plane of application that is of interest. By “symmetrically include” it is meant that the light-loss surface occurs in the periphery of the fiber on the portion of the periphery facing an impact, and on the portion facing away from the impact. Furthermore, the width of the light-loss surface is adjusted to be narrow enough to maximize throughput for an unbent fiber, and wide enough or containing sufficient loss regions within a given width and length to produce an acceptably large modulation of light level with bending.

Light-loss zones may preferably be created by abrasion, ablation, or impact, combined with light-absorption. The objective is to create a loss zone with an amount of loss invariant over time, but that varies with bending. Treatment to form the loss zone may vary from low-depth abrasion of the surface, in which case a thoroughly absorptive layer is applied to ensure full loss of scattered light, to high-depth notches, which may not require significant additional absorptive layer to obtain full modulation by bend. However, the light-absorbing layer will always be desirable for reducing the effects of light from other sources external to the fiber, and may include adhesive properties and sealing properties. An example of abrasion is roughening by sandpaper or sand-blasting. An example of ablation is removal of material at low temperature by ultraviolet laser. An example of impact treatment is pressing a sharpened blade into the fiber to create notches.

In the description of various embodiments of the invention above, and in the detailed description below the term “optical sensor” or “optical fiber sensor” or “optical fiber array” includes fiber or light guides of any cross sectional shape and size.

### BRIEF DESCRIPTION OF THE DRAWINGS

FIG. 1 is a perspective view of the front portion of a vehicle embodying the invention;

FIGS. 2(a) and 2(b) illustrate sensor deformations;

FIGS. 3, 4 and 5 illustrate various characteristic curves for sensors;

FIGS. 6 and 7 are end view and side view respectively of non-distributed sensing zone;

FIGS. 8 and 9 are similar views at a sensing zone having axially and peripherally distributed loss regions;

FIGS. 10, 10(a), 10(b), 10(c), 11, 11(a), 11(b) and 11(c) are side views of further arrangements of loss regions;

FIGS. 12, 13 and 14 are an end view, side view and perspective view respectively of a sensor having two peripherally distributed axial loss regions.

FIGS. 15 and 16 are side views illustrating two different forms of surface treatment at loss regions;

FIGS. 17,18 and 19 are side views, similar to FIG. 9, illustrating other arrangements of loss regions on a sensor;

FIG. 20, a side view as in FIGS. 17, 18 and 19, illustrates an alternative form or shape of loss region;

FIGS. 21, 22 and 23 are end view, side view and perspective view respectively of a fiber having a sensor with four peripherally distributed axially extending light-loss regions;

FIGS. 24, 25, 26(a) and 26(b) illustrate different forms of an array;

FIGS. 27, 28 and 29 illustrate further different forms of array;

FIG. 30 is a side view of a sensing zone, incorporating an impression film on the fiber;

FIG. 31 is a cross-section through a typical bumper, with array applied;

FIG. 32 is the section in the circle A on FIG. 30 to a larger scale; and,

FIGS. 33, 34 and 35 are plan views of a bumper with mechanical system shown for control inflections of bend.

### DETAILED DESCRIPTION OF THE PREFERRED EMBODIMENT

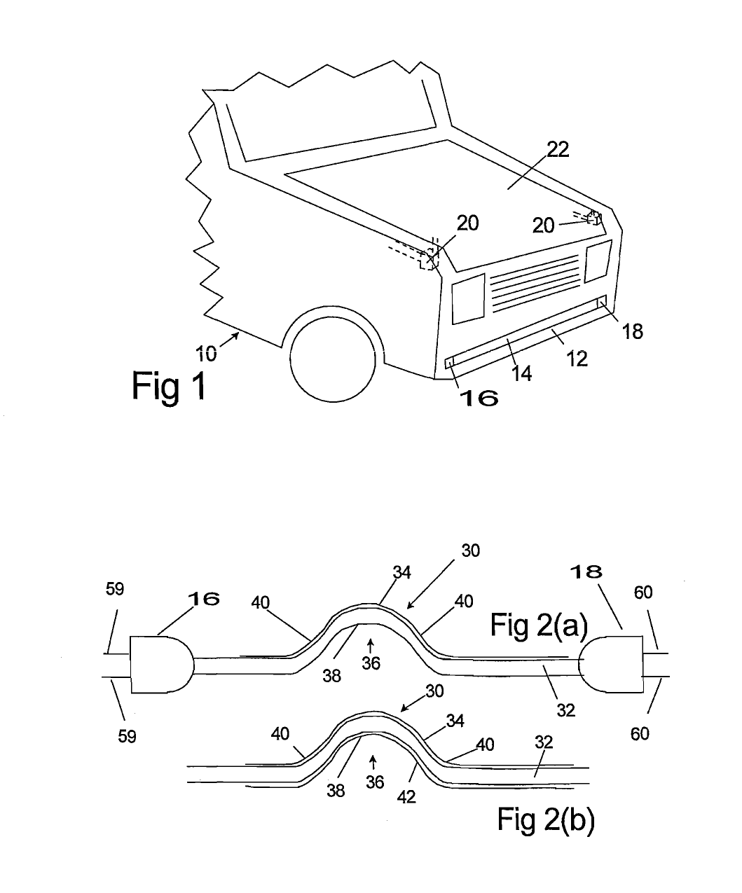

FIG. 1 illustrates the front end 10 of a vehicle having a bumper 12 extending across at the front. Attached to the bumper 12 is an optical fiber sensor array 14. In the particular arrangement shown, a light emitting source 16 and a light detector 18 are connected to the fiber or fibers in the array 14, one at each end. As described later light source 16 and light detector 18 can both be at the same end. The light source and light detector are connected to a control system (not shown) in the vehicle. Devices 20 are provided to “pop” or lift the hood 22, on receipt of a signal from the control system.

The invention provides various forms of optical fiber arrays and various forms of sensors for detecting, classifying and measuring inflected and non-inflected bends, their progression in time and to calculate shape, mass and velocity of intruding objects and also to identify such objects by shape, resilience, vibration and dampening. It is not necessarily a requirement that all of these determinations be obtained at all times, the actual determination being selected to suit the particular requirements of the method and apparatus.

FIG. 2(a) illustrates a sensor zone or area, indicated generally at 30, comprising a fiber 32 having a light-loss area 34, on one side. The light-loss area is created by modification of at least the outermost optically transmissive and reflective portions of the fiber, namely the cladding of the fiber, and usually also includes modification of the core of the fiber, immediately below the cladding. The modifications, described elsewhere in the description, affect the ability of the fiber to transmit light by internal reflection or refraction, by permitting light to leave the optically transmissive portions (core and cladding). In the case of graded-index fibers, there is no optically active cladding, but rather a diminution, in the core, of refractive index toward the periphery. Thus, in a graded-index fiber, which has no cladding, the outer portions of the core would be modified to effect a light-loss. A sheath or jacket on the fiber, if present, is optically active only in the absorption of light leaving the fiber, or in the absorption of environmental light that might otherwise enter the fiber. However, the function of optical absorption may be performed by application of optically opaque coatings as described elsewhere in the description. Sheaths, jackets, and coatings, which are normally considered optional adjuncts to a fiber rather than part of the fiber, may also have non-optical functions such as mechanical protection and sealing against moisture. Similarly, impression films in this patent specification are external to the cladding, and have a mechanical function only. The foregoing remarks apply to all loss areas portrayed in this patent specification.

FIG. 2(a) also shows a light source 16, in this case a light-emitting diode (LED) by way of example, with electrical terminals 59 for injection of current to illuminate the LED and thereby the fiber 32. FIG. 2(a) also illustrates a photodetector 18, in this case a photodiode by way of example, with electrical terminals 60 for applying photocurrent to an electronic amplifier, typically a transimpedance amplifier for conversion of photocurrent to signal voltage. The source 16 and detector 18 are representative of the light sources and detectors throughout this patent specification. A deformation 36 is shown. This is a bipolar situation, with the loss area on one side, and the bends 38 and 40 may add to zero or another deceptive value. This cannot be repaired by subsequently taking the absolute value of the modulated signal. The ability to sense inflected shapes can be improved somewhat if the single loss area is arranged to produce a bipolar but nonlinear response (more modulation for one polarity of bend than another, yet still bipolar). In that case, inflected bends with equal positive and negative components will produce a non-zero change in throughput, but bends with unequal components can still produce no response or a misleading response (e.g. two different ‘dents’ can produce the same response).

FIG. 2(b) illustrates a non-bipolar arrangement, with the fiber 32 having light-loss areas 34 and 42 on opposite sides of the fiber. The modulation of the light signal through the fiber will be the sum of the absolute values of the bends, so there will always be a non-zero result. It might be thought that with the loss areas on opposite sides, a given bend would lead to increased throughput due to the concave-out side and decreased throughput for the other side, and a cancellation of modulation would occur. However, this is not the case because most of the light in the fiber is directed toward the convex-out side and impinges on the loss area, and the other side has minimal interaction with the light.

Various characteristic curves for sensors can be combined in an array to facilitate classification and measurement.

FIGS. 3, 4 and 5 illustrate different curves which can be obtained. FIG. 3 is for a fiber having light-loss area on both sides, with a bi-polar and symmetrically linear characteristic. In FIG. 4 there is a light-loss area on one side but small loss or unequal loss areas on both sides. This gives a bipolar and asymmetrical linear (non-linear) characteristic. In FIG. 5 there is a light-loss area on one side optimized for linearity. This gives a bipolar and symmetrically linear characteristic.

The configuration of FIG. 4 with two unequally lossy areas on opposite sides may take on the characteristic curve shown in FIG. 4, in which case the response is bipolar and linear for positive and negative bends but the response is attenuated at a different absolute value of positive bend than of negative bend, depending on the amount of loss per unit bend for each side. As shown in FIG. 4, for small bends, the response is linear. For larger absolute values of bend, the slope of the response curve is attenuated as shown in FIG. 4, imparting a nonlinear property to the sensor, with a different breakpoint of slope (change from large slope to lesser slope) for positive and negative bends. The loss areas may be adjusted in width, depth, or number of loss sites per surface area of loss zone to take on different values of loss. By varying these parameters, the response may be tailored to have the characteristic curve shown or, if there is very little or no loss on one side, the characteristic curve within a range of bend intensifies comprising all intensities of practical use, may be the same as that of a fiber with a loss zone on one side only. The cases illustrated in FIGS. 3, 4 and 5 demonstrate a continuum of responses that may be produced by various cases of bilateral loss (loss areas on both sides), varying from equal loss on both sides to no loss on one side. All of these cases are preferable to circularly symmetrical loss (loss area completely surrounding the circumference) because the geometry is made specific to a plane of maximum response, and the throughput is thereby maximized for a given amount of response to bend.

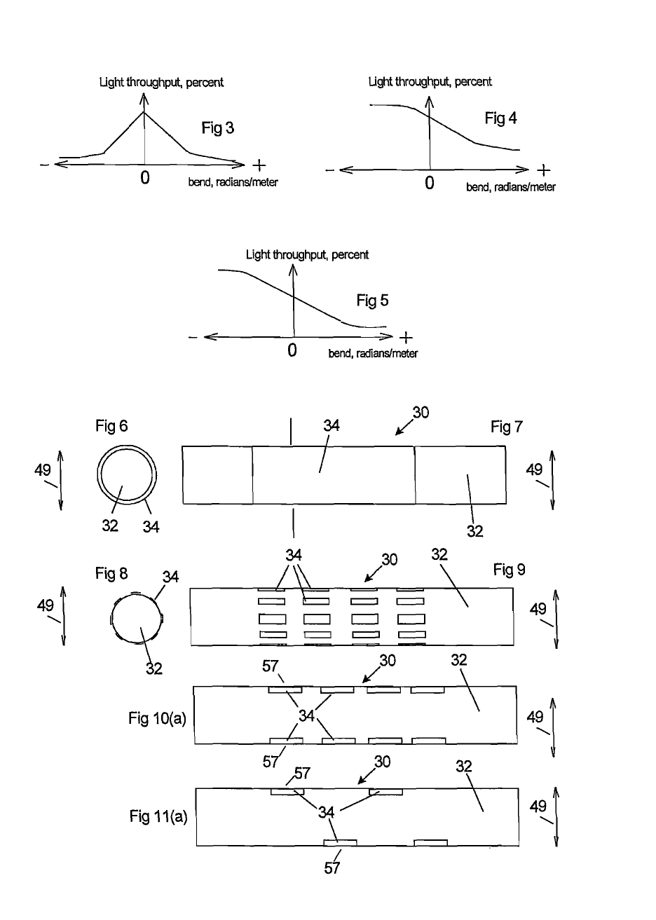

The design of a sensor of any given characteristic curve involves tradeoffs of modulation percentage and throughput. In FIGS. 6 and 7, the fiber 32 has a complete peripheral loss area 34, extending axially. This acts as a large single loss area to detect a bend in any plane but has a low throughput for a given modulation percentage.

In FIGS. 8 and 9 a sensing zone or area has a plurality of loss areas 34, distributed peripherally and axially, again detecting a bend in any plane. This gives an increased throughput with little loss in modulation percentage if an impact is aligned in a plane containing the light-loss areas. This has improved throughput.

In FIGS. 6, 7, 8, 9, 10(a-c), 11 (a-c), and 12, a direction of impact is shown in the plane of the page by arrows 49. For the circularly symmetrical loss areas shown in FIGS. 6 through 9, the direction is immaterial. But for the geometry of FIGS. 10(a-c) and 11 (a-c), the direction matters.

In FIG. 10(a) there are axially and peripherally distributed light-loss areas optimized to detect a bend in a single plane-the plane of drawing as shown by arrow 49. In FIG. 10(a) the axial centers 57 of the loss areas (located midway between the ends of each loss area; the two centers for one pair are shown by way of example) are aligned on opposite sides of the fiber. As in FIG. 2(a) and (b), the loss areas in the figures represent modification of at least the cladding, and normally include modification of the core.

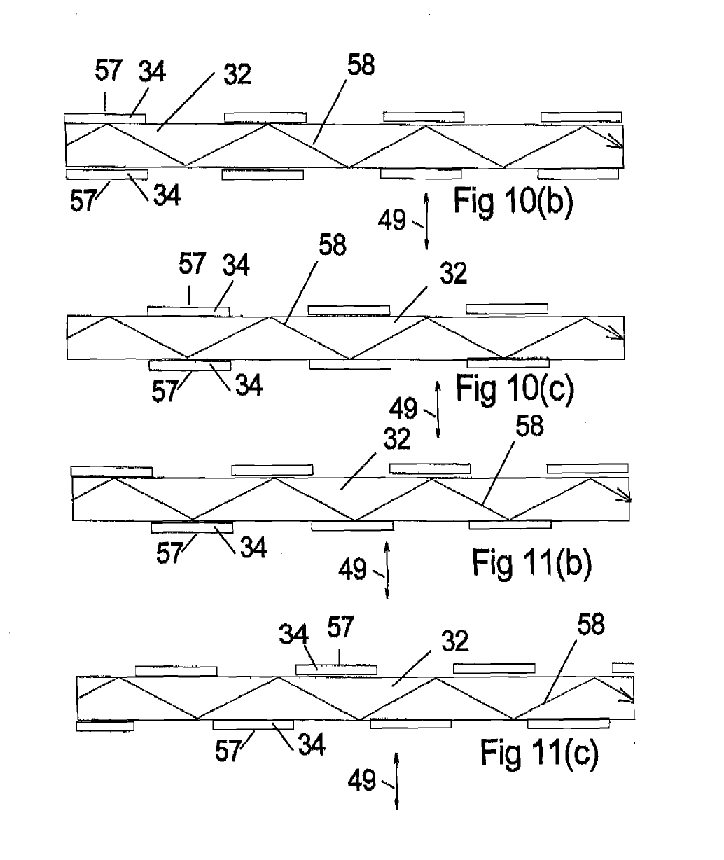

FIG. 11(a) is similar to FIG. 10(a), but optimized for throughput By displacing the axial centers of the loss areas 57 (the two centers for one pair are shown by way of example) axially on one side of the fiber vs. the other, the throughput can be enhanced because modes lost on one side of a straight fiber, if not lost, but rather reflected, would have formed a significant population of the modes striking a downstream loss area on the other side of the fiber. When the fiber is bent during an impact, this situation changes, so that modulation is similar to that achieved without axial displacement of loss areas on one side. The background for the statement about modes is that when any fiber (treated for loss or not) is bent, light flux in the core will increase toward the outside of the curve and away from the inside of the curve. Additional background is that treated or untreated fibers will lose high-order modes of light preferentially over lower-order modes. Untreated fibers begin to lose light when bent below a minimum radius of curvature. Fibers treated purposely with loss areas, or having loss areas accidentally created through unintentional abrasion, will lose more light at the areas for modest curves compared to the curves required for loss from untreated fibers. High-order modes are those impinging on the core-cladding interface at maximum angles with planes tangent to the surface of the fiber. As an example for step-mode fibers, the highest modes are those travelling through the fiber near the maximum cone angle describing the collection of rays that are able to propagate by refraction at the core-cladding interface. Since high-order modes are lost preferentially at loss areas, the loss areas can be described as mode filters, analogous to the mode filters made by wrapping optical fiber around a mandrel to strip out high-order modes. This is what underlies the difference seen experimentally between opposed loss surfaces and staggered loss surfaces.

FIGS. 10(b-c) and 11(b-c) illustrate that higher-order modes persist farther in a Fiber with staggered loss areas than in one with loss areas directly across from each other. FIG. 10(b) illustrates a ray of light 58 travelling down an optical fiber from left to right, before loss areas 34 with axial centers 57 have been created in the cladding and/or core. The ray is meant to represent high-order modes at or near the maximum cone angle. The loss areas in FIG. 10(b) are in opposed pairs (only the first pair is labelled to reduce clutter in the drawing), with axial centers 57 directly opposite within each pair. Once the loss areas have been created, the ray would be lost at the first loss area (No. 34 at upper left of drawing). FIG. 10(c) illustrates that no matter where the areas are moved axially along the fiber, there is no geometry that would permit propagation of high-order modes. (Although in the illustration we have moved the areas and not the ray, the same argument applies to moving the ray and not the areas). If such a fiber is bent, flux will move toward the outside curve, and losses will increase because of two effects: more rays impinge on the outer-curve loss areas, and the curve raises the angles of impingement so that increasingly lower-order modes are lost as the curvature increases. However, the drawback to the geometry of FIGS. 10(a-c) is that throughput for a straight fiber is low, due to the lack of paths of propagation for high-order modes (they are stripped out by the mode filtering effect).

FIG. 11(b) shows that for the same ray, a staggered arrangement of loss areas (axial centers within a pair are not aligned) can also lead to total loss of the ray at the first such loss area (No. 34 at upper left of drawing). However, if the areas are moved with respect to the example ray as shown in FIG. 11(c), it can be seen that there are high-order rays 58 that can propagate through such a fiber without striking loss areas. Thus, the staggered areas can be less of a mode filter than the opposed areas. In the geometry of FIGS. 11(a-c), if the fiber is bent, the increased flux toward the outer curve will contain higher-order modes than the geometry of FIGS. 10(a-c), and modulation of the light will be more aggressive (higher change in throughput per change in bend), because the geometry of loss areas on the outer curve FIG. 11(c) is the same as that of FIG. 10(c), but the light of FIG. 11(c) contains higher modes than the light of FIG. 10(c).

It should be clear that by varying the axial lengths and spacings of the loss areas, a wide variety of interactions with modes can be achieved. But the illustrations are intended to show a simple example that proves that staggering can produce different, and more useful effects than with opposed areas. Axial displacement is limited usually to approximately one half to one length of a loss area, and should in any event not be so large that the loss area on one side of the fiber is exposed to significantly different shapes than that on the other side.

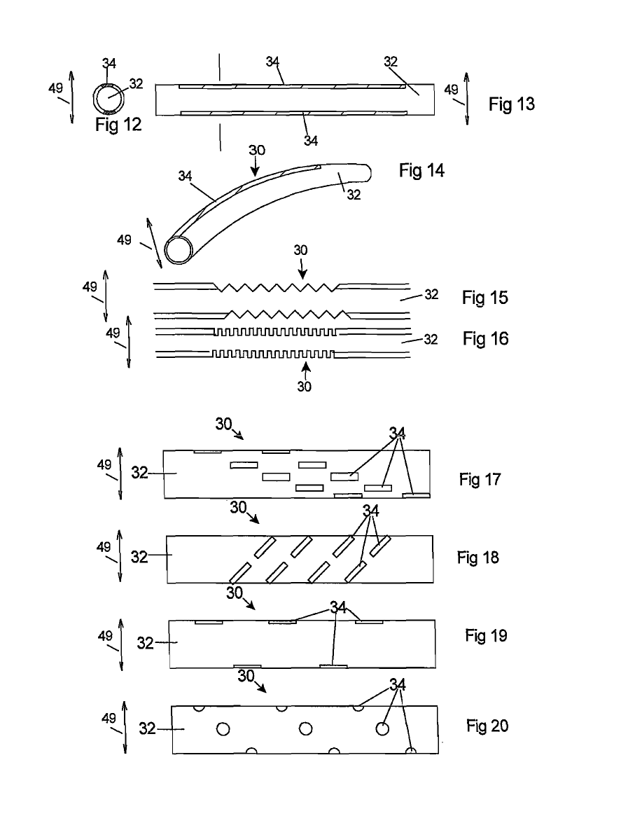

For sensors covering from millimeters up to a few centimeters, the loss areas can be continuous along the fiber, and have large features resulting in large loss within the loss area, but throughput is kept high by limiting the peripheral extent to the plane of maximum sensitivity (i.e., narrow, continuous loss areas facing toward and away from an impact). Treatment of the fiber surface can be carried out, as by impression, laser ablation, abrasion and other means. FIGS. 12, 13 and 14 illustrate a fiber 32 having two peripherally spaced axially extending loss areas. These form a sensing zone, or region, maximally sensitive to bending in direction 49 in the plane containing the loss areas. FIGS. 15 and 16 illustrate two alternative forms of surface treatment-FIG. 15 is serrated and FIG. 16 crenellated. The serrations and crenellations penetrate the cladding and can also penetrate the core. FIGS. 10(a-c), 11(a-c), 13, 14, 15 and 16 all have two opposed bands containing loss areas, as represented in cross section by FIG. 12. Preferably, the bands are aligned with the direction of impact 49.

In general, the sensor zones or regions are comprised of continuous or distributed light-loss areas which can be spaced peripherally and axially. Preferably, the peripheral distribution, or spacing, should be limited to that required to achieve a characteristic curve (such as non-bipolar and linear) with maximum sensitivity in the plane of impact (i.e., treat two sides), and axial distribution, or spacing, should be optimized for a trade-off of throughput and modulation percentage. FIGS. 6, 7, 8 and 9, above, illustrate one form of light-loss areas and FIGS. 17,18,19 and 20 illustrate further various forms of the spacing of light-loss regions 34. In FIG. 17 the areas 34 are in a helical pattern, with elongate areas 34 extending axially. In FIG. 18 the areas 34 are in a helical formation, with the elongate areas 34 extending along the helical line. In FIG. 19 the areas 34 are on opposite sides, alternating axially, side-by-side. FIG. 20 illustrates areas 34 of a different shape, in the example generally circular. In the example, the areas are spaced helically, axially along the fiber 32.

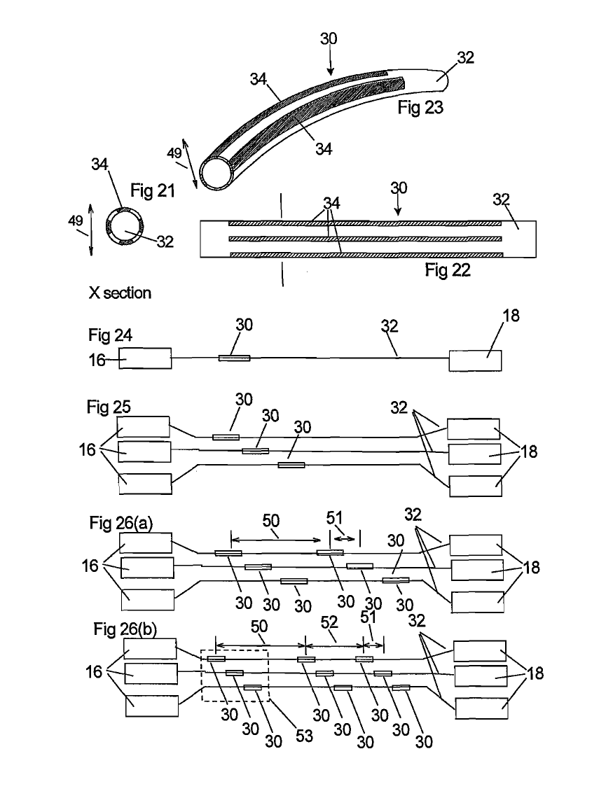

FIGS. 21, 22 and 23 illustrate an example of a high-throughput fiber sensitive in two planes. FIGS. 6, 7, 8, 9, 17, 18, and 20 represent geometries of loss that, due to circular symmetry, are insensitive to the direction of impact (shown as arrows 49). FIG. 19 illustrates a geometry maximally responsive to impact in the direction 49. FIGS. 20, 22, and 23, with cross section illustrated by FIG. 21, have a response, as mentioned above, that is maximal for two axes of impact (along arrow 49 in the paper, and along an axis perpendicular to the paper). The sensor zone 30 of fiber 32 has four peripherally spaced axially extending light-loss areas 34. This forms a sensing zone maximally sensitive in two planes.

System design of a sensor array can vary. FIGS. 24, 25, 26(a) and 26(b) illustrate three arrays. In FIG. 24, there is a single light guide or fiber 32, with a light source 16 at one end and a light detector 18 at the other. There is a sensor zone or region 30 which has one or more light-loss areas, extending axially and peripherally spaced to fall symmetrically in a plane of maximum sensitivity. In FIG. 25 there is a multiplicity of light guides or fibers 32, in the example three, with light sources 16 at one end and light detectors 18 at the other. The sensor zones or regions 30 are spaced axially, each at a unique axial location. In FIGS. 26(a) and 26(b) there is a plurality of light guides or fibers 32 each having a light source 16, a light detector 18, and a series of sensor zones or regions 30 axially spaced along each fiber. The sensor zones in the fibers are axially spaced so that they are axially distributed relative to the sensor zone in each fiber. In this arrangement wider objects actuate more sensors.

Alternatively mass and velocity (and type) are inferred from the time progression of the signals, but the location of the impact will not be known. In FIGS. 25, 26(a) and 26(b), the fibers are shown with loss areas distributed axially. Their lateral extent is preferably confined to a narrow band, for ease of manufacture, and so that response will vary with width (along the axial direction of fibers), but not in the lateral direction (the narrow dimension of the band). In FIG. 25 the sensing areas are distributed axially, and appear only once on each fiber, in a distinct, non-repeating axial location along the fiber, different from axial locations of sensors on the other fibers of the band, so that response of any fiber indicates magnitude as well as axial location along the band. FIGS. 26(a) and 26(b) illustrate placement of at least two sensing areas on each fiber, spaced at intervals along the fiber, so that axial location of any impact along the band will not be known, but magnitude (from which mass, velocity, and type are computed) will be reported. In FIG. 26(a) the inter-sensor spacing intervals along each fiber 50 are the same (within the fiber) and the inter-sensor spacing from fiber to fiber 51 are the same for any adjacent fibers so the effect on magnitude of response due to width or axial location along the band will be the same, due to the regular spacing of sensor areas along fibers. In FIG. 26(b) the sensors are placed on a fiber at different spacings 50 and 52, but are grouped into multiple groups. A representative group 53 is shown enclosed in a dotted rectangle. Within each group the sensor spacing 51 is the same. The case of FIG. 26(b) can be useful in placing more sensors near a critical area, such as toward one end of the bumper if the consequence of impact is greater there.

Where peripherally opposed pairs of light-loss bands or areas are formed, the bands or areas of a pair are preferably peripherally aligned. However, one band or area of a pair can be axially displaced relative to the other less than half the band length on the axial centres of the bands.

The optical fiber sensor array (14 in FIG. 1) can be made in a continuous strip, cut to length. It can have the light source and detector at both ends or at one end.

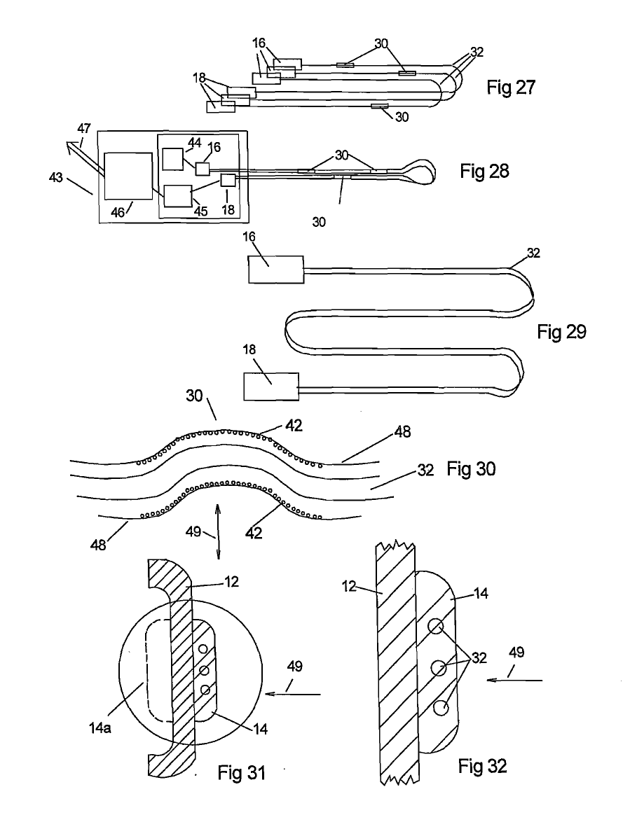

FIGS. 27, 28 and 29 illustrate arrangements in which the optical fibers in the array are looped back on themselves; providing for the light source and the light detector to be at the same end. In FIG. 27 the fibers 32 are looped and the sensors 30 are positioned to provide an axially spaced positioning. In FIG. 28 the light sources 16, light detectors 18 and electronics for the control system are located at a single location 43. The electronics comprise driver circuitry 44 for supplying the light sources with power, detection circuitry 45 for amplifying the electrical output of the detectors and changing it to digital form, an electronic control system (data processing control unit) 46 processing the digital signals according to algorithms for detecting and classifying impacts, and a communication channel 47 to actuators effecting deployment of safety systems based on the signals and algorithms. A ribbon cable of optical fibers can be manufactured in a continuous band, with the sensor zones formed, and the ribbon cut to length, then looped for return. The sensors can be in either half of the ribbon if both halves of the ribbon face the impact.

In FIG. 29, a fiber ribbon is looped to run at various heights to form an array for detecting both axial and lateral locations and shapes of impacts. Sensors are positioned as required.

In FIGS. 24, 25, 26(a) and 26(b) and In FIGS. 27, 28 and 29, the direction of impact is into the plane of the drawing. In FIGS. 30, 31 and 32 the axis of impact is shown as direction arrow 49.

FIG. 30 illustrates a sensor zone 30 on a fiber 32, having an impression film 48 on both sides, the films having a textured pattern 42 for impression of microbends in a fiber when pressure is present. Light-loss occurs from pressure and bending in presence of the light-loss area created by the microbends (synergistic effect). This is discussed above.

The optical fiber array 14 is attached to the bumper 12, for example the front outside surface as illustrated in FIGS. 31 and 32. FIG. 32 shows the array to a larger scale and, again, as an example, three optical fibers 32 are shown. Alternatively, the array 14 can be attached on the inside surface of the bumper, as indicated in dashed outline 14(a) in FIG. 31.

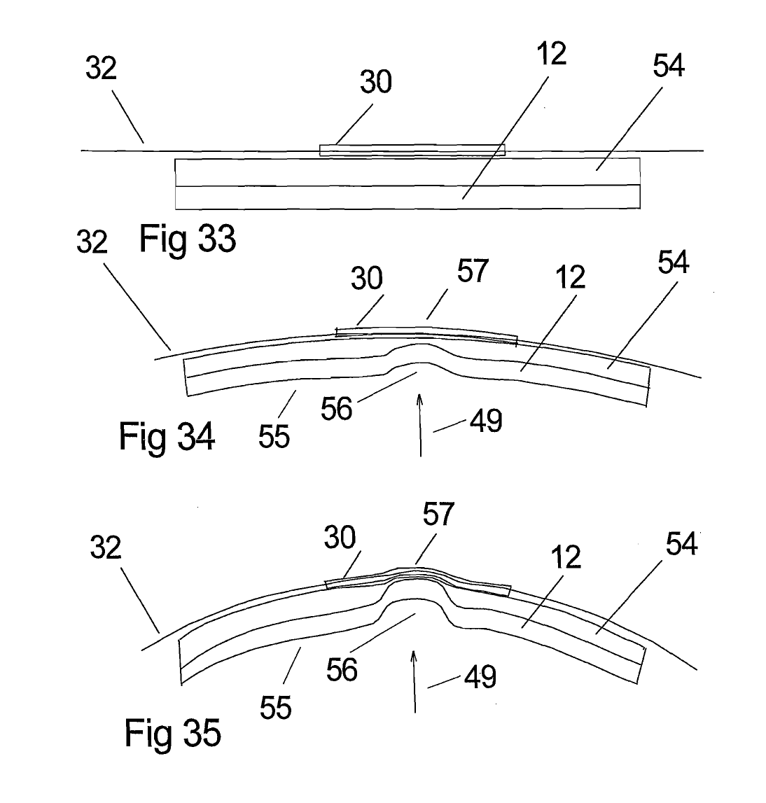

FIG. 33 illustrates an axial portion of a bumper 12 viewed from above. A sensor band 32 with representative sensor zone 30 is attached to the foam strip 54, which is in turn attached to the bumper. FIGS. 34 and 35 show the same portion of bumper undergoing impact from an object such as a leg. The impact is along vector 49 and causes a broad portion of the bumper to bend away from the impact with a low bend 55, all of the same polarity and extending along a large portion of the bumper, and also with a dent 56 near the impact, extending a short distance along the bumper. The dent has two polarities of bend (an inflected bend). Both broad bend 55 and the narrower dent 56 increase in geometric magnitude during the progression of the impact. However, the foam prevents the inflections from impinging immediately on the sensor band such as at location 57 as shown in FIG. 34. After the foam is compressed beyond a compression limit, the sensor zone 30 will begin to be subjected to the inflected portion of the bend at representative location 57, as shown in FIG. 35. In FIG. 33, the sensor 30 is unbent. In FIG. 34 the sensor is bent with approximately the broad curvature 55. In FIG. 35 the sensor is bent with a combination of the (now larger) curvature 55 and an additional inflected curvature 56. The configuration of FIGS. 33-35 can be used to diminish multiple curvatures at the sensor during the initial portion of an impact, as outlined earlier in the Summary of the Invention.

The array can be applied to the bumper at a completion stage of the bumper, for example, or applied after complete manufacture. It is possible to apply the array after final assembly of the vehicle. Such after assembly attachment would occur, for example, as a retroactive up-date to existing vehicles. In such instances an array could be packaged and sold as an item for attachment to existing vehicles. Suitable electronic connections would be made to a control system, or the like, positioned at a convenient place in the vehicle.

In operation, normally the sensor(s) on the bumper will convert light signals to digital signals, which will be fed to an electronic control system having an algorithm such as that described above (other algorithms can be used as will be understood by those skilled in the art). Once the signals are received by the electronic control system, the system will send a trigger to the safety deployment system (such as the activation of the hood being raised, etc.) when required.

The array installation can vary in complexity depending upon the desired information required. Thus it can merely detect, and indicate, that an impact occurred. Towards the other extreme, the speed of distortion or bending of the bumper and array, the severity, possibly the shape, and also the position can be detected, with appropriate signals produced. The signals can be used to cause actuation of various safety devices. In addition, or alternative to the popping open of a hood, actuation of air bags can be obtained. A further possibility is the actuation of a safety device, which could be the opening of the hood, to act as a deflector, such as would act to deflect an animal either up, or to the side, on impact, or to activate the airbags to protect occupants when an animal strike is detected. It often occurs that when a vehicle hits an animal, such as a horse, deer or other similar animal, the animal often goes through the windshield, causing severe injuries to occupants of the vehicle.

Some objectives for installations are:

(a) a low number of sensors, for example sixteen or fewer, for economical reasons;

(b) classification by type of impact and measurement of mass and velocity, which can be of more importance than exact knowledge of location (a likely goal being to locate to nearest quarter of a bumper length);

(c) response from a sensor should include information that can be processed to extract mass and velocity information-should be more than an on/off information; and, (d) response should be the same anywhere along a given sensitized length of fiber (sensor length).

A most useful type of sensor is in most cases a linear bipolar one, but non-linear and non-bipolar sensors can also be used if suitably designed and installed, in cases where economy dictates the use of fewer sensors.

Broadly, a sensor zone on a fiber provides a sensor having a variety of forms of light-loss areas. The areas can vary from those which extend completely peripherally around the fiber, to thin strips along the fiber. With peripherally extending loss areas, two or more are spaced axially, to give an axial dimension to the sensor. For thin strips, normally two at least are provided, spaced circumferentially, and extending axially to give an axial dimension. Other forms, such as helical and other formations can be provided, and the actual shape of the light-loss areas can vary, subject only to the requirement that a sensor has light-loss areas spaced peripherally and extending axially.

What is claimed is:

1. An apparatus for sensing impacts between a vehicle and an object, comprising: an optical fiber sensor for positioning on the vehicle, said optical fiber sensor including at least one optical fiber, a light source at one end of said optical fiber, a light detector at the other end of said optical fiber, and at least one sensing zone on the fiber, each said sensing zone comprising an area through which light is lost from the core of the fiber, on a side of the fiber facing towards a direction of expected impact and on another side of the fiber facing away from the direction of the expected impact.

2. The apparatus as claimed in claim 1, said sensing zone comprising a single helical band of light-loss areas.

3. The apparatus as claimed in claim 1, said sensing zone comprising a band of light-loss area facing toward the direction of expected impact and another band of light-loss area facing away from the direction of expected impact.

4. The apparatus as claimed in claim 1, said sensing zone comprising pairs of light-loss area bands, each pair including a band facing the expected direction of impact and another band facing away from the expected direction of impact.

5. The apparatus as claimed in claim 3, wherein said optical fiber is adapted to be positioned in a mechanical structure which prevents the formation of bends having multiple polarities within the length of said sensing zone.

6. The apparatus as claimed in claim 4, the axial centres of said bands of said pair being axially aligned.

7. The apparatus as claimed in claim 4, the axial centre of one of said bands of a pair axially displaced from the axial centre of the other one of said pair up to half the axial separation between centers of said pairs.

8. The apparatus as claimed in claim 1, comprising a plurality of said optical fibers positioned at different axial locations on each fiber.

9. The apparatus as claimed in claim 8, said axial locations distinct and non-repeating over each fiber for locational information indicative of impact, and intrusion depth, shape and time progression.

10. The apparatus as claimed in claim 8, said axial locations on each fiber repeated at regular intervals along each fiber, the axial locations on each fiber differing from the axial locations on the other fibers, the entire axial extent being sensitive to impacts but non-indicative of the axial location of an impact.

11. The apparatus as claimed in claim 4, including at least one fiber having non-bipolar response and at least one fiber with bipolar response for differentiation between inflected intrusions and non-inflected intrusions.

12. The apparatus as claimed in claim 1, wherein said optical fiber sensor is an array of optical fibers attached to a front surface of a bumper of said vehicle, each fiber having a plurality of sensing zones comprising narrow axial light-loss strips facing toward and away from the direction of impact with the front bumper, the change in light throughput of each fiber being the sum of bending of the light-loss strips, independent of polarity.

13. The apparatus as claimed in claim 1, wherein said fiber further comprises a first side facing towards a direction of expected impact and a second side facing away from the direction of the expected Impact, the amount of light-loss at said first side being adjusted relative to the amount of light-loss at said second side to obtain a desired response to bends of at least one polarity within said sensing zone.

14. The apparatus as claimed in claim 13, wherein said light-loss of said first side is adjusted to produce a bipolar response in which the polarity of curvature within each said sensing zone is indicated by the polarity of light.

15. The apparatus as claimed in claim 14, wherein one of said loss areas has minimal or zero loss.

16. The apparatus as claimed in claim 13, wherein said light-loss of said first side is adjusted to produce a non-bipolar response in which the polarity of curvature within each said sensor zone is not indicated by polarity of light modulation where the number of sensors per length of array is to be minimized and data from time progression of the impact is sufficient to classify Impacts as to type of object and mass.

17. The apparatus as claimed in claim 13, wherein said light-loss of said first side is adjusted to produce an attenuated response to bending above a first desired positive bend value and an attenuated response to bending below a second desired negative bend value.

18. In a vehicle having a pedestrian impact sensing system, the improvement wherein said vehicle includes:
a plurality of sensors mounted in the front area of said vehicle and adapted to sense an impact between a pedestrian and the front area of the vehicle; said sensors each comprising a plurality of light-loss areas on a fiber, spaced axially; and
a data processing control unit having stored data, said data processing central control unit being adapted to compare an event upon receipt of a signal from at least one of said sensors with stored data, and being adapted to generate an output signal upon evidence of a threshold value determined by said stored data, said output signal adapted to actuate a safety device.

19. A method of sensing impact between a vehicle and an object comprising:
providing said vehicle with a front structure having a plurality of sensors, each sensor comprising a plurality of light-loss areas on a fiber, spaced axially, each sensor having signal output means for feeding a signal upon an in-pact to a data processing control unit;
providing a data processing control unit having stored algorithms for measuring and classifying impact shape, mass, and velocity based on the signal outputs from the sensors; said control unit being operatively associated with said signal output means of each of said sensors;
said data processing control unit being adapted to compare an event upon receipt of a signal from at least one sensor, with stored data in said control unit; and,
said control unit being adapted to generate an output signal upon evidence of a threshold value determined by said stored data, said output signal being adapted to actuate a safety device.

20. The method of claim 19, further comprising positioning said fiber sensor on said vehicle, said fiber sensor including at least one optical fiber having a light source at one end, a light detector at the other end and at least one sensing zone on the fiber, each sensing zone comprising a light-loss area located on the periphery of the fiber, on a side of the fiber facing toward a direction of expected impact and another light-loss area located on the periphery of the fiber on a side of the fiber facing away from said direction of expected impact, detecting modulation of a light signal resulting from said Impact and generating said signal for actuation of said safety device.
